(19) United States
(12) Patent Application Publication
(10) Pub. No.: US 2009/0047523 A1
(43) Pub. Date: Feb. 19, 2009

(54) Production of discrete shaped article

(76) Inventor: Vincent W. Keedy, JR., New Castle, DE (US)

Correspondence Address: E I DU PONT DE NEMOURS AND COMPANY;LEGAL PATENT RECORDS CENTER, BARLEY MILL PLAZA 25/1122B, 4417 LANCASTER PIKE, WILMINGTON, DE, 19805, US

(21) Appl. No.: 11/891,809

(22) Filed: Aug. 13, 2007

(51) Int. Cl. B32B 9/04; C08L 97/02

(52) U.S. Cl. 428/411.1; 524/14

(57) ABSTRACT

Disclosed is a process that can be used to produce surface covering such as mulch. The process comprises combining at least one ethylene copolymer, at least one filler, at least one cellulosic material, and optionally a decoupler, a plasticizer, a coloring agent, or combinations of two or more thereof to produce a mixture; converting the mixture into a sheet or slab; and contacting the sheet or slab between a set of engraved nip rolls to produce shredded article including mulch.

The invention relates to a process for producing an article including artificial surface covering or ground cover such as mulch or a substitute for wood mulch using a filled polymer.

### BACKGROUND OF THE INVENTION

Shredded tires can be used as surface or ground covering such as artificial mulch, but they are encumbered with deficiencies including unpleasant odor, possible metal contamination, heavy metals, and inadequate supply. Such contaminations are unpleasant and unsafe when use as a playground cover and not environmentally friendly. Surface or ground covering having desired properties, such as pleasant scent, little or no metal contamination, little or no heavy metal content, and relatively high specific gravity to prevent wash out during heavy rains, can comprise an ethylene copolymer. However, known processes for producing surface covering are not as efficient in achieving desired aesthetics as one skilled in the art desires. Therefore, there is a need to develop a process to produce such surface covering and the development of such surface covering product at low cost would be a great contribution to the art.

### SUMMARY OF THE INVENTION

A process that can be used to produce surface covering comprises, consists essentially of, or consists of, producing a heat-processable composition; converting the composition into a slab; contacting or feeding the sheet or slab between a set of rotating nip rolls to produce an article wherein the slab is optionally heated and the nip rolls can be heated before being contacted with the sheet.

### DETAILED DESCRIPTION OF THE INVENTION

Any heat-processable product or composition can be used such as polymers or clays. For example, a composition that can be used to produce ground covering such as artificial mulch can include at least one ethylene copolymer, at least one filler, at least one cellulosic material, and optionally a de-coupler, a plasticizer, a coloring agent, or combinations of two or more thereof wherein the cellulosic material can include wood flour; the de-coupler can be a dimer of an organic acid or acid derivative, a trimer of an organic acid or acid derivative, or combinations thereof; the acid itself optionally has about 15 to 30 carbon atoms; the plasticizer includes processing oils, epoxidized oils, polyesters, polyethers, polyether esters, or combinations of two or more thereof.

A heat-processable composition is converted to a slab or feedstream of desired width, length and thickness, the dimensions may depend on the design of the nip rolls. For example, it can be about less than one inch, 0.01 to about 5, about 0.01 to about 3, or about 0.08 to about 2 inches thick, about 12 inches to a few feet long and about 3 inches to about a few feet wide (1 inch=2.54 cm and 1 foot=12 inches). Converting the composition into a slab can be carried out by creating a mixture of the materials, if not a single polymer, in a commercial mixing unit to produce a composition. One such commercial unit is known as a continuous mixer (CM). The output of the CM can then be fed into an extruder through a slot die to produce a substantially rectangular (or other shapes) continuous slab of materials, which can then be calendered by means of a set of smooth nip rolls to set a fixed gap of the desired thickness slab. If, for example, a final slab thickness of 0.09 inches and width of 6 inches is desired, the slot die may have to be approximately 1 inch by 4 inch and the calender rolls can be set to a fixed gap of 0.09 inches. Processing temperatures may vary with composition of material but for the composition described elsewhere in this application the material coming from the extruder may be about 330° F. (about 166° C.) and exiting the calender at about 220° F. (about 104° C.). It is desirable to cool the calendered product immediately or as soon as possible upon exiting the calender to below about 130° F. (about 54° C.) using air or even water spray. This cooling may serve to prevent damage to the slabs due to handling and packaging.

The nip rolls can have cavities or pockets engraved with any desired forms such as simulated wood mulch (or other pattern) which can be pressed together with the material (e.g., the slab) between the rolls with sufficient force to produce individual particles of ground covering. The engraved cavity or pocket can include regular or irregular shapes or forms. Examples of shapes or forms can include such as triangular, rectangular, circular, irregular, film, foam, mulch, molded character, letter, number, logo, mascot, cartoon characters, puzzle, animal, plant, trademark such as DuPont® oval, shell (e.g., sea shell), or combinations of two or more thereof. The perimeter (or edge) of each cavity is desirably of substantially zero depth in the radial direction in order to create discrete pieces of articles. This perimeter of each cavity in the circumferential direction is desirably about 0.001 to about 1 or 0.01 to 0.04 inch wide to allow for some roll misalignment axially and rotational.

Without material between the rolls, it is desirable to keep a gap of less than about 0.025 mm (0.001 inch) between the rolls such that any connection web at the flat perimeter areas during forming at the nip) may be minimized. Keeping the gap small may facilitate separation of each article into individual pieces at the exit end of the nip. Desirably substantially zero web thickness joining the pieces may be ideal, but in reality it may be impossible because the forming rolls can interfere with each other if no gap is set (due to thermal expansion that must be accounted for and controlled) thereby causing damage to the forming rolls. The nip rolls can also be set at any other gaps so long as such gaps can minimize any connection web at the flat perimeter areas during forming at the nip. It is also useful to provide compression rings with no cavities at the ends of each roll (or mid way as needed with long rolls). These compression rings may be at the “zero gap” diameter of the engraved rolls. In that way if the means by which the 0.001 inch gap setting fails then the rolls would rest against each at the compression rings thereby guaranteeing that they cannot imbed into each other and be damaged.

Each nip roll can have a width of about less than one inch or about 2 inches to about 5 feet and a diameter of about 8 inches to about 3 feet.

The rolls can be engraved using any conventional, commercial engraving techniques such as, for example, acid etching process or engraving technique and geared together (i.e., the top half of an article on one roll matches with the bottom half on the other roll). That is, the rolls can be geared together (or electronically “geared” together) to keep the perimeter flat areas in registration both radial and axially. For example, the engraved nip rolls can be made by engraving techniques. One such technique is to laser scan selected samples of existing wood or rubber mulch and transferring this scanned data into digital photo enhancing software where it can be manipulated to obtain the desired result. This data manipulation includes creating the small perimeter (above) flats around each engraved cavity of about 0.015 to about 0.022 inches wide which later become the separation lines of the individual pieces of mulch. After manipulation in software the rolls can be engraved using conventional acid engraving techniques. The depth of the engraved rolls varies with the pattern and may have cavities a maximum of 1/16 inch deep creating particles of ground covering which are twice this or about ⅛ inch thick. However, any thickness of material can be possible. For example, for production of articles of about ⅛ inch thick one may start with a slab or plank of material that is about 0.088 to about 0.092 inch thick. The thickness of the slabs is desirably matched to the depth of the engraved cavities to produce a satisfactory result. It may be useful for the engraved rolls to have special plating for mold release. Mold release plating of a metal surface is well known to one skilled in the art. Generally it involves the coating of the surface with Teflon® with or without metal. The metal can include nickel, chromium, or combinations thereof. The usual thickness of flash hard metal (chrome or nickel plating) is minimal, at about 0.0003 to about 0.0005 inch. The engraving can be carried out by any conventional metal engraving process.

The slab of the heat-processable material can be heated to a temperature of about 125 (or lower) to about 300° F. (about 52 to about 149° C.), about 150 to about 250° F. (about 66 to about 121° C.), or about 175 to about 225° F. (about 66 to about 107° C.) before entering a nip with engraved rolls. This can be accomplished by passing the slabs on a conveyor under an infrared heater (or through an oven). For example, this can be done on a conveyer (e.g., about 20 meters long) passing under an infrared heater of about 25 kw power. This preheated conveyor can be a few inches higher in elevation than the nip area between the rolls. The heated slabs can then be fed down an inclined metal chute, about 12 to 18 inches long, wide enough to accommodate the slab width, into the nip area. This chute can be cooled with chilled water cooling coils on the bottom to prevent the slabs from sticking to the chute and piling up in front of the nip rolls. The chute temperature can be kept below about 50 or about 40° C. to prevent sticking. At the bottom of the chute the nip rolls “catch” the slabs and pull them into the nip between the rolls.

The nip rolls can be heated before being contacted with the sheet or slab to about 65 to about 120° C. or about 85 to about 110° C. before the sheet or slab enters the nip. The nip rolls can be heated by any means such as electrical resistance heaters, hot oil, or other techniques. The existing rolls may have internal resistance heaters and a temperature controller to maintain a desired temperature.

The nip rolls can be operated under a pressure of from about 1000 to about 10000 pound per linear inch (1 pound per inch=17.858 kg/m) of the nip contact length of the rolls. For example, if the rolls are 12 inches wide the force to push them together can be at least about 12×4000=48,000 lbs.

The cavities formed in the rolls, as in any molding process, can be the net shape of the desired resulting product. In this case they are the volume at the rolling nip of the two forming rolls, similar to a crater on the moon. Similar to molding processes, engraved cavities dictate the net shape of the desired resulting product or the volume at the rolling nip of the two forming rolls. Each cavity along with its mate on the opposite roll makes one piece of article such as mulch. In a way this is like a combination of compression molding/embossing and rotary die cutting. Each cavity, along with its mate on the opposite roll, makes one piece of ground covering. This is also similar to a combination of compression molding/embossing and rotary die cutting, two known technologies but not previously combined together.

A scraper including knifes, blade, or any scraping devices, such as a doctor blade, can be positioned against the nip/engraved rolls on the exit side to help remove material from the rolls. The end can be tangent to the engraved roll such as by using a spring temper blade and flexing it so as to have its end tangent to the engraved roll facing the product approaching it. The material that comes in contact with the scraper is nudged, lifted, and/or rolled can be removed like a scraping action from the rolls and begins to fall downward into individual pieces. The individual pieces of shaped articles can fall straight down from the nip rolls onto a receiving and transporting device such as conveyor and optionally be lifted by, e.g., a flight exit conveyor that can reheat the article pieces to reduce any stress lightening and help separate any remaining joining webs and, thereafter, further transport to a vibratory conveyor followed by cooling and falling into a collection device such as a drum or carboy for packaging.

Alternatively, a rotating brush, running counter-currently to the nip rolls, can be pressed against the nip/engraved rolls on the exit side to help remove any material from the rolls.

Post heating on an exit conveyor can act to melt this joining web. Even with a 0.001 inch or less gap between rolls occasionally some pieces of the shaped articles may not separate and are held together by a thin web of material. Separation can be assisted by re-heating the material on the exit conveyor to soften the thin webs between the pieces until they are almost melted and then vibrating or shaking on a vibrating tray at the end of the conveyor to complete the separation.

Wishing not to be bound by theory, if the nip/engraved rolls are too hot the material may stick in the cavities and become hard to get out on the downstream side. Any pieces of slab or sheet articles that do not fall apart, can be re-heated on the exit transporting device which softens the thin webs between the pieces until they are melted or almost melted. The pieces can drop onto a vibrating tray which makes the remaining attached pieces fall apart.

If two tone (one color on one side and another color on the opposite side) articles are desired then two slabs of different color, each which is 50% of the thickness of final desired slab, can be fed together, one on top of the other into the nip rolls. The resulting-articles then are one color on one side and another color on the opposite side. Each slab can also be multicolored.

A heat-processable composition desirably comprises, consists essentially of, or consists of, based on the total weight of the mixture, about 5 to about 40, about 10 to about 30, or about 15 to about 25, weight % of the ethylene copolymer; about 0.1 to about 10, about 1 to about 7, or about 2 to about 5 such as about 3, weight % of the plasticizer; about 0.01 to about 5, about 0.1 to about 2, or about 0.1 to about 1 such as about 0.4, weight % of the decoupler; about 30 to about 90, about 30 to about 80, or F about 50 to about 70, weight % of the filler; and about 0 to about 30, about 1 to about 25, about 3 to about 20, or about 5 to about 15, weight % of the cellulosic material. The composition can have a specific gravity of <2 such as from about 1 to about 1.9, about 1.2 to about 1.7 about 1.3 to about 1.6, or about 1.3 to about 1.5 such as about 1.45.

The composition can comprise about 0.01 to about 10 weight % of one or more pigments, dyes, or flakes, or combinations of two or more thereof to provide pigmented solid color, pearlescent pigment and/or other nacreous pigment for colored metallic appearance properties. Pigments include both clear pigments such as inorganic siliceous pigments (e.g., silica pigments) and conventional pigments including metallic oxides (e.g., titanium dioxide, and iron oxide; metal hydroxides), metal flakes (e.g., aluminum flake), chromates (e.g., lead chromate), sulfides, sulfates, carbonates, carbon black, silica, talc, china clay, phthalocyanine blues and greens, organo reds, organo maroons, other organic pigments, dyes, or combinations of two or more thereof.

The composition may also comprise 0.001 to about 10 weight % of one or more additives including UV light stabilizers, antioxidants, thermal stabilizers, fillers, anti-slip agents, plasticizers, nucleating agents, or combinations of two or more thereof.

Ethylene copolymer can include one comprising repeat units derived from ethylene and comonomer including vinyl ester; vinyl acetate, α-olefin, α,β-unsaturated carboxylic acid or ester thereof, vinylidene, or combinations of two or more thereof. Examples of α-olefins include propylene, butene, pentene, 4-methyl-1-pentene, hexene, octene, decene, dodecene, or combinations of two or more thereof. Vinyl ester can include esters of saturated C₁₋₄ carboxylic acids such as vinyl acetate, vinyl propionate, vinyl butyrate, or combinations of two or more thereof. Examples of α,β-unsaturated carboxylic acids include (meth)acrylic acid, maleic acid, fumaric acid, a C₁₋₈ alkyl ester of the acid, or combinations of two or more thereof. The copolymer can further include repeat units derived from additional comonomer such as CO, SO₂, an epoxy-containing carboxylic acid, or combinations of two or more thereof.

Ethylene/vinyl acetate copolymer can include copolymers comprising repeat units derived from ethylene, vinyl acetate, and optionally an additional comonomer. Vinyl acetate and/or comonomer incorporated into the copolymer can vary from about 1 to about 45, about 3 to about 35, or 6 to 30, weight % of the copolymer. The comonomer can include an unsaturated carboxylic acid or its derivatives, such as maleic anhydride or maleic acid. A combination of two or more different ethylene/vinyl acetate copolymers can be used.

An ethylene copolymer can be produced by any means well known to one skilled in the art.

For example, a tubular reactor-produced ethylene/alkyl (meth)acrylate copolymer, which denotes an ethylene copolymer produced at high pressure and elevated temperature in a tubular reactor and is generally stiffer and more elastic than autoclave produced ethylene/alkyl acrylate copolymer. Tubular reactor produced ethylene/alkyl acrylate copolymers of this nature are commercially available under the tradename Elvaloy® AC from E. I. du Pont de Nemours & Company, Wilmington, Del. (DuPont).

The ethylene copolymer can comprise, by weight, based on the ethylene copolymer, about 40 to about 95, about 50 to about 90, or about 70 to about 88% of repeat unit derived from ethylene and about 5 to about 60, about 10 to about 50, or about 12 to about 30% of repeat units derived from the comonomer including the additional comonomer (about 10 to about 100% of the comonomer) and can have a melt index range from about 0.1 to about 400, about 0.1 to about 50, or about 0.1 to about 10 g/10 min (ASTM 1238, 190° C., 2.16 Kg). Two or more ethylene copolymers can be blended together.

Examples of ethylene copolymers include ethylene/vinyl acetate, ethylene/acrylic acid or its ionomers, ethylene/methacrylic acid or its ionomers, ethylene/methyl acrylate, ethylene/ethyl acrylate, ethylene/isobutyl acrylate, ethylene/n-butyl acrylate, ethylene/isobutyl acrylate/methacrylic acid or its ionomers, ethylene/n-butyl acrylate/methacrylic acid or its ionomers, ethylene/isobutyl acrylate/acrylic acid or its ionomers, ethylene/n-butyl acrylate/acrylic acid or its ionomers, ethylene/methyl methacrylate, ethylene/vinyl acetate/methacrylic acid or its ionomers, ethylene/vinyl acetate/acrylic acid or its ionomers, ethylene/vinyl acetate/carbon monoxide, ethylene/methyl acrylate/carbon monoxide, ethylene/n-butyl acrylate/carbon monoxide, ethylene/isobutyl acrylate/carbon monoxide, ethylene/vinyl acetate/monoethyl maleate, ethylene/methyl acrylate/monoethyl maleate, or combinations of two or more thereof.

Wishing not to be bound by theory, a decoupler such as dimer acid or trimer acid can enhance elongation and increase melt index such as at high filler loadings. Decoupler can also include a monomeric organic acid such as stearic acid, oleic acid, linoleic acid, linolenic acid, or combinations of two or more thereof. Such dimer or trimer acids can be derived from mono- or poly-unsaturated acids in which one or more of the olefinic bonds of a monomeric acid molecule reacts with one or more of the olefinic bonds of other monomeric acid molecules to form acyclic, cyclic, aromatic or polycyclic dimers and/or trimers. Generally a mixture of structures results, with cyclic addition products predominating. For example, dimer acids (CAS Number 61788-89-4) and trimer acids (CAS Number 68937-90-6) derived from C₁₈ fatty acids such as linoleic acid can be used. The unsaturated bonds remaining after dimerization or trimerisation can be hydrogenated to provide fully saturated dimers or fully saturated trimers. Dimer and trimer acids can be obtained from Arizona Chemical Company, Panama City, Fla. (such as Unidyme®). Mixtures of the these acids can be employed such as a mixture containing at least 51% and about 55% trimer acids (measured by gas chromatography) is commercially available as Unidyme®. Mono-, di-, and/or tri-valent metal salts of these organic acids, including calcium, zinc, magnesium, or combinations of two or more thereof, salts of fatty acids can be used.

The plasticizer can include processing oils, epoxidized oils, polyesters, polyethers, polyether esters, or combinations of two or more thereof.

The processing oils can include paraffinic, aromatic, naphthenic, or combinations of two or more thereof. Paraffinic oils tend to “bleed” from blends. Bleeding is normally not desirable, but could be useful in specialty applications, for example, in concrete forms where mold release characteristics are valued. Naphthenic and aromatic oils are nonbleeding when used in proper ratios. Processing oils can also be subdivided by viscosity range. Thin oils have 100-500 SUS (Saybolt Universal Seconds) at 100° F. (38° C.). Heavy oils can have high as 6000 SUS at the same temperature. Processing oils such as naphthenic and aromatic oils with viscosity of from about 100 to 6000 SUS at 38° C. can be used.

Epoxidized oils can include epoxidized soybean oil and epoxidized linseed oil.

Polyesters, polyethers, and polyether esters are well known to one skilled in the art. A polyester, polyether, and/or polyether ester can also be mixed with one or more processing oils where the processing oil can be present from about 50% or higher by weight.

Filler such as calcium carbonate, calcium sulfate, barium carbonate, barium sulfate, alumina, silica, glass, glass fiber, perlite, or combinations of two or more thereof may modify the density of the mixture. The filler can have any particle size or shape. Fine particle size fillers may have a tendency to result in higher blend viscosities.

One or more cellulosic materials can be used such as those obtained from wood and wood products, such as wood flour; wood pulp fibers; non-woody paper-making fibers from cotton; straws and grasses, such as rice and esparto; canes and reeds, such as bagasse; bamboos; stalks with bast fibers, such as jute, flax, kenaf, cannabis, linen and ramie; and leaf fibers, such as abaca and sisal; paper or polymer-coated paper including recycled paper and polymer-coated paper. Preferably the cellulosic material is from a wood source including softwood sources such as pines, spruces, and firs, and hardwood sources such as oaks, maples, eucalyptuses, poplars, beeches, and aspens. The form of the cellulosic materials from wood sources can be sawdust, wood chips, wood flour, or combinations of two or more thereof.

In addition to sawdust, agricultural residues and/or waste can be used. Agricultural residues are the remainder of a crop after the crop has been harvested. Examples of such suitable residues include residues from the harvesting of wheat, rice, and corn, for example. Examples of agricultural waste suitable for use herein include straw, corn stalks, rice hulls, wheat, oat, barley and oat chaff, coconut shells, peanut shells, walnut shells, jute, hemp, bagasse, bamboo, flax, and kenaff, and combinations thereof.

The cellulosic materials may be screened through various screens, e.g., a 30-mesh or a 40-mesh screen, to obtain a mixture of different size material. The size of the cellulose material used in the mixture can range from about 10 to about 100 mesh or about 40 to about 100 mesh.

The wood flours include soft and hard woods and combinations thereof. Preferable wood flours are oak and pine, available as OAK 4037 (40 mesh) and PINE 4021 (40 mesh), respectively from American Wood Fibers of Schofield, Wis. Maple wood flour can also be used.

The coloring agent can include organic or inorganic pigments such as ochre, iron oxide, phthalo blue, alizarin, alizarin crimson, gamboge, indigo, carbon black, ivory lack, cobalt pigment (e.g., cobalt blue, cobalt violet, aureolin), chromium pigment, copper pigment, titanium pigment, zinc pigment, or combinations of two or more thereof. The final product can be red, brown, blue, green, metallic, black, or combinations of two or more thereof.

The composition can also comprise about 0.001 to about 10 weight % of an additive including one or more extender resins, waxes, foaming agents, crosslinking agents, UV stabilizer, carbon black, titanium dioxide, other pigments or dyes, optical brighteners, surfactants, hydrolytic stabilizers, anti-static agents, fire-retardants, lubricants, reinforcing agents (e.g., glass fiber and flakes), antiblock agents, release agents, processing aids, antioxidants, a tackifier resin, or combinations of two or more thereof. The tackifier may be any tackifier known in the art such as those disclosed in U.S. Pat. No. 3,484,405 including natural and synthetic resins and rosin materials; coumarone-indene resins (e.g., coumarone-indene resins including commercially marketed as Picco-25 and Picco-100); terpene resins including styrenated terpenes (e.g., commercially marketed as Piccolyte S-100, Staybelite Ester #10, or Wingtack 95); butadiene-styrene resins (e.g., Buton 100 or Buton 150, a liquid polybutadiene resin); hydrocarbon resins (produced by catalytic polymerization of selected fractions obtained in the refining of petroleum including those marketed as Piccopale-100); styrene hard resins (e.g., disproportionated pentaerythritol esters, and copolymers of aromatic and aliphatic monomer); and rosin (e.g., gum, wood or tall oil rosin, dimerized rosin, hydrogenated rosin disproportionated rosin, or esters of rosin), resins.

The composition can be produced by any means known to one skilled in the art such as blending, mixing, or extrusion. For example, a commercial batch-type Banbury, Farrel continuous mixer, or equivalent mixer or can be used for mixing/blending. Also for example, dry components can be charged to a suitable vessel such as reactor, bowel, container, extruder, or other mixing chamber. Alternatively, masterbatch of smaller components such as the decoupler and/or plasticizer can be prepared and then injected directly into a vessel to obtain thorough mixing. A mix cycle of about 1 to about 120 minutes at about 125° C. to about 200° C. can be effective or sufficient. Once blends are mixed, routine commercial practices may be used, such as underwater melt cutting plus drying or use of sheeting plus chopping methods, to produce a final mixture in pellet form. Alternately, the hot mixture also may be immediately fabricated into a final form, e.g., sheeting, molding, strip, or combinations of two or more thereof.

The articles can include any shapes or forms as the engraved shapes or forms disclosed above and thickness such as from about 12 μm (about 0.5 mils) to about 40000 μm (about 1600 mils).

The article can have the same shapes or forms.

### EXAMPLE

The example is provided to illustrate, not to be construed as to unduly limit the scope of, the invention.

Ethylene vinyl acetate copolymer (19.450 lb; available from DuPont, Wilmington, Del. as ELVAX® 470; contained 18% vinyl acetate and had a Ml of 0.7 g/10 min), a trimer of linoleic acid (0.400 lb; derived from tall oil obtained as a byproduct in the treatment of pine pulp and obtained from Arizona Chemical Company, Panama City, Fla. as Unidyme®; CAS 68937-90-6), a naphthenic oil (3.000 lb; obtained from Ergon, Vicksburg, Miss. as L750 oil), CaCO₃ (66.275 lb; obtained from Imerys, Roswell, Ga. as CC103), pine sawdust 2041 (10.000 g lb; obtained from American Wood Fibers, Columbia, Md.), carbon black concentrate (0.075 lb; obtained from Polyone Corporation, Seabrook, Tex. as 2447) and red pigment (0.800 lb; obtained from Lanxess Corporation, Burgettstown, Pa. as Bayferrox 140M) were mixed in a continuous mixer for one minute at 165° C. and 450 rpm to produce a mixture. The mixture at 160° C. was fed into a calender at room temperature with a fixed gap to produce a slab of about 0.09 inch thick, 6 inch wide, and 24 inches long.

The slab was then fed to nip rolls, each of which was 14 inches long, 8 inches in diameter. The top roll was heated at 71° C. and the bottom roll was heated at degree or two less. The rolls were engraved with irregular mulch-like shapes of about 0.06125 inch deep. At the exit, a doctor blade was set against the roll to remove the molded products, which were dropped to a conveyor and collected. The products had mulch-like shapes and were red or black in color and smelled like wood. The color was throughout the product and wearing of surface did not change the color of the product. The product was used as ground covering.

1. A process comprising producing a heat-processable composition;
converting the composition into a slab; contacting the slab between a set of engraved nip rolls to produce articles wherein the slab is optionally heated.

2. The process of claim 1 wherein the roll is engraved to include the mulch particles in the shape of triangle, rectangle, circular, irregular form, film, foam, molded character, letter, number, logo, mascot, cartoon characters, puzzle, animal, plant, trademark, or combinations of two or more thereof.

3. The claim 1 wherein the slab comprises two slabs having different colors.

4. The process of claim 2 wherein the nip roll has a width of less than one inch to about 5 feet and a diameter of about 8 inches to about 3 feet.

5. The process of claim 4 wherein the nip roll includes a scraper at the end of the roll to facilitate the removal of the article and the scraper is pressed tangentially against the roll.

6. The process of claim 5 wherein the scraper is doctor blade.

7. The process of claim 4 wherein the nip roll includes a rotating brush at the end of the roll to facilitate removal of the article and the brush is pressed tangentially against the roll wherein the brush rotates at the opposite direction of the roll.

8. The process of claim 6 wherein the slab is heated to a temperature of about 52 to about 149° C. before entering nip rolls.

9. The process of claim 4 wherein the nip rolls is heated to a temperature in the range of from about 32 to about 107° C.

10. The process of claim 7 wherein the article is mulch having the shape of triangle, rectangle, circular, irregular form, film, foam, mulch, molded character, letter, number, logo, mascot, cartoon characters, puzzle, animal, plant, trademark, or combinations of two or more thereof.

11. The process of claim 12 wherein the composition includes cellulosic material; a decoupler including a dimer of an organic acid or acid derivative, a trimer of an organic acid or acid derivative, or combinations thereof; the acid itself optionally has about 15 to 30 carbon atoms; the plasticizer includes processing oils, epoxidized oils, polyesters, polyethers, polyether esters, or combinations of two or more thereof; mixture further comprising the plasticizer.

12. The process of claim 11 wherein the ethylene copolymer comprises repeat units derived from ethylene, comonomer, and optionally additional comonomer wherein the comonomer includes vinyl ester, α-olefin, α,β-unsaturated carboxylic acid or ester thereof, vinylidene, or combinations of two or more thereof and the additional comonomer includes CO, SO₂, an epoxy-containing carboxylic acid, or combinations of two or more thereof; wherein the decoupler is one or more metal salt of the organic acid and the metal is calcium, zinc, magnesium, or combinations of two or more thereof; and the plasticizer is a processing oil.

13. The process of claim 12 wherein the comonomer is the vinyl ester.

14. The process of claim 13 wherein ethylene copolymer comprises two different ethylene/vinyl acetate copolymers; the cellulosic material includes wood, wood product, wood pulp fiber, non-woody paper-making fiber from cotton, straw, grass, cane, reed, bamboo, stalk with bast fibers, leaf fibers, or combinations of two or more thereof; and the plasticizer comprises naphthenic oil; and the filler is calcium carbonate, calcium sulfate, barium carbonate, barium sulfate, alumina, silica, glass, glass fiber, perlite, or combinations of two or more thereof.

15. The process of claim 14 wherein the filler is calcium carbonate and the cellulosic material includes wood flour, sawdust, wood chip, or combinations of two or more thereof.

16. The process of claim 15 wherein the cellulosic material is wood flour.

17. An article produced by producing a heat-processable composition; converting the composition into a slab; contacting the slab between a set of engraved nip rolls to produce articles wherein the slab is optionally heated and the article is mulch.

18. The article of claim 17 wherein the article has the shape of triangle, rectangle, circular, irregular form, film, foam, mulch, molded character, letter, number, logo, mascot, cartoon characters, puzzle, animal, plant, trademark, or combinations of two or more thereof.

19. A surface having covered thereon an article as recited in claim 18.
